(19) United States
(12) Patent Application Publication
(10) Pub. No.: US 2003/0159544 A1
(43) Pub. Date: Aug. 28, 2003

(54) Method for the production of a tool, in particular a drill or milling cutter

(76) Inventors: Bernhard Moser, Altshausen (DE); Rainer Widmann, Langenargen (DE); Hans-Peter Fuessl, Schlier (DE); Marco Lang, Ravensburg (DE)

Correspondence Address: VENABLE, BAETJER, HOWARD AND CIVILETTI, LLP, P.O. BOX 34385, WASHINGTON, DC, 20043-9998, US

(21) Appl. No.: 10/375,076

(22) Filed: Feb. 28, 2003

(30) Foreign Application Priority Data
Feb. 28, 2002 (DE) 102 08 633.8
Sep. 18, 2002 (DE) 102 43 403.4

(51) Int. Cl. B23C 5/10

(52) U.S. Cl. 76/108.6; 29/557; 29/558; 407/54; 76/108.1

(57) ABSTRACT

The invention relates to a method for the production of a tool, in particular a drill (6) or milling cutter, having at least one conveying helix (8a, 8b), proceeding from a bar-shaped blank (1). In this case, there is provision for introducing the conveying helix (8a, 8b) in a single operation by means of a machine tool, the blank (1) having a diameter (D_{R}) which is larger than a diameter (d_{F}) of the conveying helix (8a, 8b).

The invention relates to a method for the production of a tool, in particular a drill or milling cutter, according to the preamble of claim 1, and to a tool produced by this method, according to the preamble of claim 15.

Hammer drills are produced conventionally from a prefabricated blank having a standardized clamping shank at a diameter of, for example, 10 mm (SDS-Plus clamping shank) which has adjoining it, for the future conveying helix, a cylindrical shank region which is adapted to the nominal diameter of the drill to be produced. If the conveying helix diameter of the drill is smaller than the diameter of the clamping shank, the blank has correspondingly a step between the clamping shank and the region provided for the conveying helix. This blank is produced, for example, as an extrusion or as what may be referred to as a lathe-turned part by an automatic bar machine. In a further operation, the conveying helix is worked into the corresponding region of the blank, for example with the aid of a chip-removing method, such as grinding or milling, or a forming method, such as rolling. In this case, the diameter of the blank shank corresponds to the diameter of the conveying helix.

Drills of this type are complicated to produce, since, first, a blank with a diameter adapted to the subsequent conveying helix diameter has to be produced. In addition to this manufacturing step, along with the corresponding handling, complicated stockkeeping is also necessary, since a multiplicity of different blanks must be kept in stock for the multiplicity of different drills.

By contrast, the object of the invention is to propose a method for the production of such a tool, in particular a drill or milling cutter, which entails a lower outlay.

Proceeding from a method of the type initially mentioned, this object is achieved by means of the defining features of claims 1 and 15.

Advantageous effects and developments of the invention are possible as a result of the measures mentioned in the subclaims.

Accordingly, a method according to the invention, in which a bar-shaped blank is provided with at least one conveying helix, is distinguished in that the conveying helix is generated in its outside diameter and its fluting in one operation by means of a machine tool. This dispenses with the work step for the separate production of a blank having a shank adapted to the conveying helix diameter. Instead, one cylindrical bar-shaped blank having a defined outside diameter can serve as an initial product for a multiplicity of tools with a different conveying helix diameter. That is to say, the stepping between the clamping shank and the region provided for the conveying helix does not in this case have to be carried out separately in a previous work step, since the conveying helix diameter is produced simultaneously with a conveying helix flute. A machining of the conveying helix flute and of the conveying helix spine thus takes place. This is important particularly in view of the fact that, for the production of drills with a different nominal diameter, blanks with different stepping have also had to be provided hitherto. A plurality of conveying helices can also be worked in in one operation. This is possible by a time-staggered and/or spatially offset action of, for example, two machine tools on the tool to be produced. Alternatively, each conveying helix can be made by means of a separate operation, and the same machine tool can be utilized for this purpose.

The conveying helix may in this case be worked in by chip removal, for example by grinding or milling with a grinding or milling tool having a corresponding profile, or else by forming. At all events, the corresponding machine tool, which normally rotates about a tool axis, must penetrate with an appropriate machining depth into the blank and simultaneously produce the conveying helix outside diameter and the conveying helix flute.

Particularly for the chip-removing manufacture of the workpiece, there is provision, according to the invention, for setting the blank in rotation about its longitudinal axis in relation to the machine tool and at the same time moving the blank and the machine tool in relation to one another in the longitudinal direction and also transversely to the latter. Alternatively to this, there is provision for causing the machine tool to rotate about the stationary or rotating blank and to move the blank and the machine tool in relation to one another in the longitudinal and transverse directions. By a variation of the speeds of movement in the longitudinal and/or the transverse direction and/or of the rotational speeds, it is possible in diverse ways to act upon the appearance of the tool generated from the blank.

In an advantageous embodiment of the invention, in this case, use is made of the possibility of the method according to the invention of varying the controllable manufacturing parameters during the production method and of thus providing drills having conveying helices which possess different properties due to the variation in geometry of the conveying helix.

Thus, for example, the machining depth of the tool, that is to say the advance of the tool in the transverse direction, may be varied during the advance of the blank. This results, in one case, in a variation in the core dimension of the drill along its length L. Depending on the design of the machine tool, the wall of the flute of the conveying helix may also have corresponding variations due to a change in the machining depth. The land radius or the conveying helix diameter can also be influenced by the variation in the machining depth. By the land radius is to be meant, in this context, the distance of the land of the conveying helix from the drill longitudinal axis. The conveying helix diameter is therefore obtained from double the land radius according to this definition.

In another embodiment of the invention, the advancing speed is varied during the advance. Regions of the conveying helix with a different pitch can thereby be produced. In this case, with the machining depth of the tool being the same, the land width of the conveying helix can also be varied along with the variation in the advancing speed.

The variation in the machining depth and/or in the advancing speed is in this case carried out preferably in a continuous operation, so that the conveying helix resulting from this has continuous transitions, without abrupt dimensional or cross-sectional changes which could lead to weak points.

In the method according to the invention, the helix runout toward the clamping shank may also be worked in in one operation. In principle, it would admittedly be possible, in this case, to work in the desired core diameter of the conveying helix without an advancing speed between the blank and the machine tool and subsequently, according to the invention, apply the conveying helix. This would, however, produce an annular flute, without a helix, in the region of the transition to the drill shank. Preferably, therefore, the helix runout is worked in in such a way that the land of the helix runout towards the clamping shank has a continuous enlargement of the land radius r.

By the land radius being enlarged in the helix runout of the conveying helix, the drill dust transport is prolonged into the region of the clamping shank, so that the useful working length of the tool is increased, that is to say, where a drill is concerned, extends over the entire length capable of being introduced into the drillhole.

Advantageously, in this case, the enlargement of the land radius is continued until the land radius (r) reaches the dimension of the shank radius (R_{E}). In this case, the land of the corresponding conveying helix merges directly into the clamping shank, as a result of which, in particular, the manufacture of the tool becomes easier.

Furthermore, it is advantageous to enlarge the land radius in the helix runout continuously, so that no kink or edge occurs in the land. In other words, the radius enlargement is continuous when no jump occurs in the change of radius along the tool axis. In mathematical terms, one would speak of a continuously differentiatable function which, as a theoretical ideal case, is as far as possible to be approximated in practice.

The continuous variation in radius of the land brings about a high rigidity of the tool in the region of the helix runout, without abrupt cross-sectional variations which always form weak points. The direct transition of the helix runout into the clamping shank, that is to say the land end, at which the land reaches the shank radius (R_{E}), may in this case perfectly well have an angling or an edge, without the rigidity of the drill being impaired. This refers to the cut-in point on the clamping shank in the case of chip-removing helix production commencing at the clamping shank.

Moreover, in a development of the invention, an enlargement of the flute radius (n) is also provided in the region of the helix runout of the conveying helix towards the clamping shank. In this context, the distance of the flute bottom from the tool longitudinal axis is to be understood as the flute radius. By virtue of this measure, the depth of the flute in the helix runout is gradually reduced, until it ends on the outer circumference of the clamping shank. This ensures chip or drill dust transport radially outward as far as the flute end.

In a particularly advantageous embodiment of the invention, in this case, the flute end of the helix runout is arranged so as to be offset in the axial direction towards the clamping shank with respect to the land end. This results, where a drill is concerned, in a greater radial flute opening outside the drillhole, even when the drill is introduced into the drillhole until it comes into the abutment.

The enlargement of the flute radius preferably likewise ends at the shank radius (R_{E}), that is to say the flute of the conveying helix commences or ends (depending on the viewing direction) directly on the outer circumference of the clamping shank.

Preferably, the enlargement of the flute radius is also produced continuously, with the result that, firstly, the material transport, in particular the drill dust transport radially outward is made easier and, secondly, the advantages in terms of tool rigidity, which were mentioned above in connection with the design according to the invention of the land, are further improved. The flute end may in this case also merge at a low angle into the outer circumference of the clamping shank. As regards chip-removing flute production commencing at the clamping shank, this transition point constitutes the cut-in point of the tool on the outer surface of the shank.

The helix runout may in this case be designed to be relatively short, without the advantages according to the invention being impaired. Thus, with the conventional pitches of the conveying helix of drills, it may be sufficient to have a helix runout which extends over an angular range of 10° to 180°, preferably over 90°.

By means of the method according to the invention, one or more conveying helices of reduced diameter, as compared with the shank diameter of the initial workpiece, and also with the helix runout can readily be produced in at least one operation extending over the entire length L_{A} of the conveying helix, into the machining depth of the corresponding machine tool, starting from the shank radius (R_{E}) or as far as the shank radius (R_{E}), is varied in a path-dependent manner. The transition between the clamping shank and the corresponding conveying helix therefore requires no separate manufacturing steps.

In a development of this production method, at least one, preferably each conveying helix, with helix outside diameter, helix flute and helix runout, is worked in, complete, in a single operation over the entire length L. Where a multispiral tool is concerned, the production of each individual conveying helix takes place in one operation.

By virtue of the above-described production of the tool according to the invention, there is no need for the provision of a stepped blank, the diameter of which has to be adapted to the desired conveying helix diameter in the region of the conveying helix. According to the invention, then, a continuous cylindrical blank can be used, which is provided merely with a standard holder or standardized holder for standardized machine tools, for example for hammer-drilling machines with what is known as a SDS-PLUS or SDS-MAX holder. Merely sufficient material for the conveying helix has to be present in the region of the conveying helix. Thus, for example, a cylindrical bar may be used, in which a standard holder as a clamping shank is formed in the end face. The standard holder (clamping shank) may in this case be worked in by forming or cutting production before or after the manufacture of the conveying helix.

If a differently designed clamping shaft is desired, then even the blank can be selected accordingly. If, for example, a clamping shank with a polygonal profile, for example a hexagonal profile, is desired, a bar with a corresponding profile may be used as the blank, so that, even by the blank being selected, the clamping shank is available without any further machining steps. Subsequently, as stated above, the complete conveying helix is worked in its outside diameter and in its fluting.

Further details of the invention are described, with reference to diagrammatically illustrated exemplary embodiments, in the drawing in which:

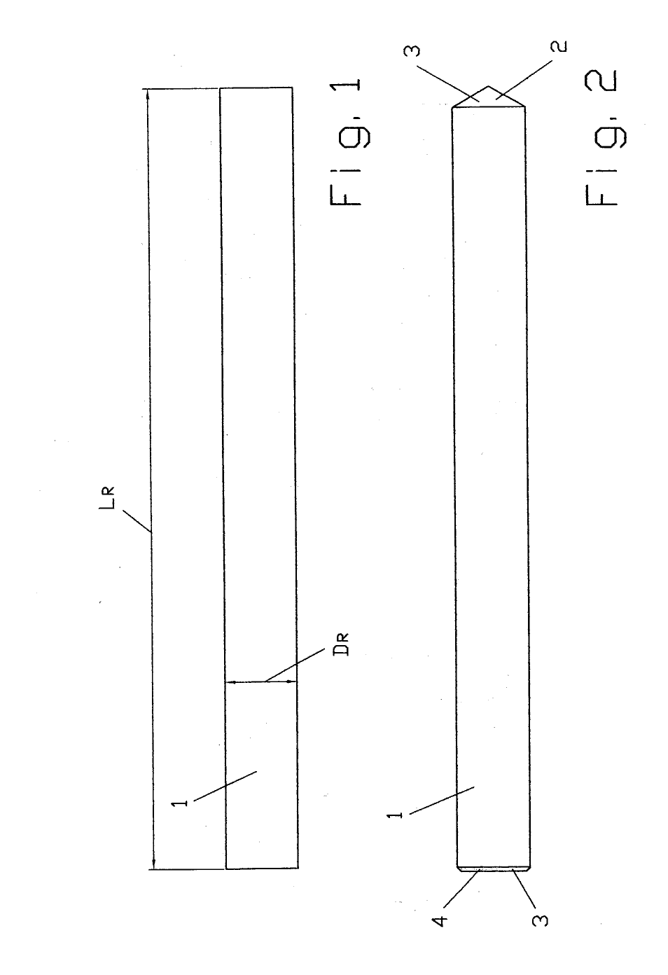

FIG. 1 shows a blank,

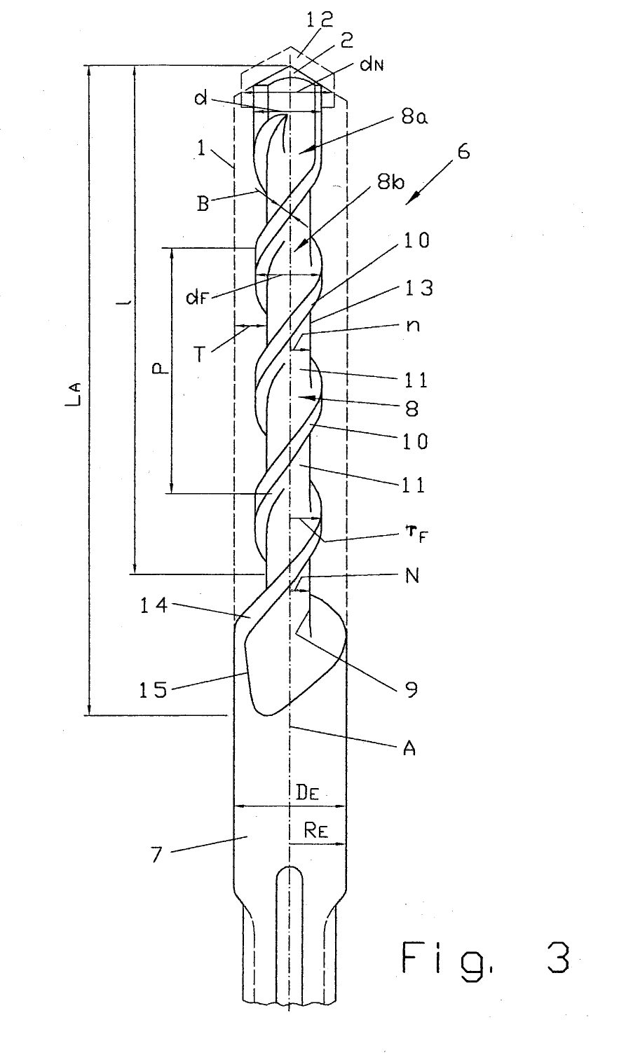

FIG. 2 shows the blank from FIG. 1 with machined ends,

FIG. 3 shows a first design variant of a double-start drill,

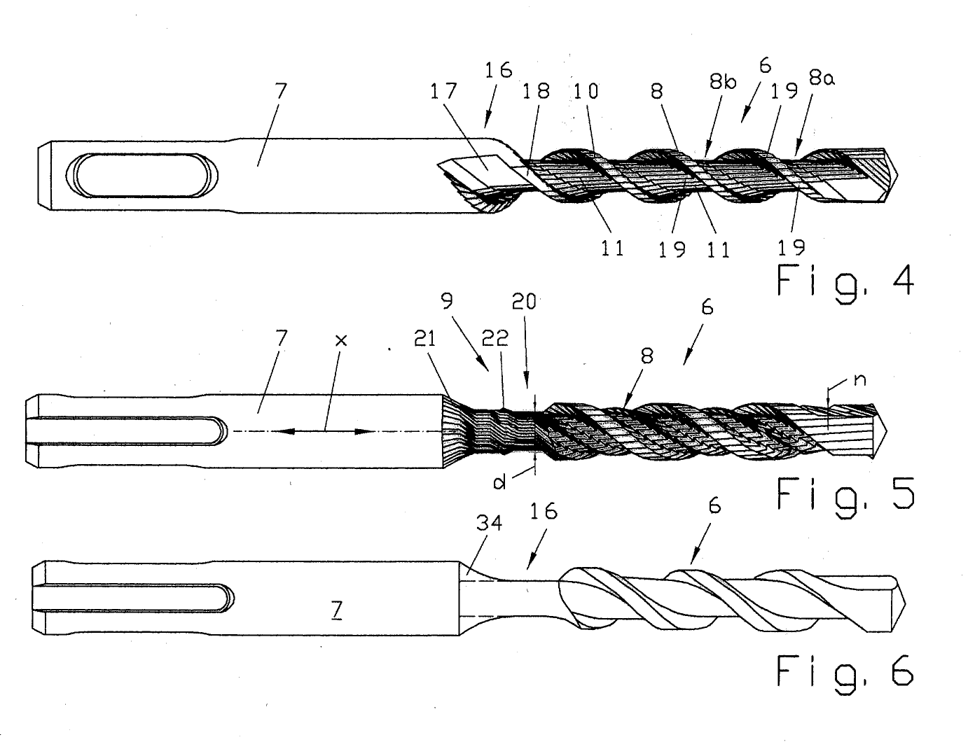

FIG. 4 shows a second design variant of a double-start drill,

FIG. 5 shows a third design variant of a double-start drill,

FIG. 6 shows a fourth design variant of a double-start drill,

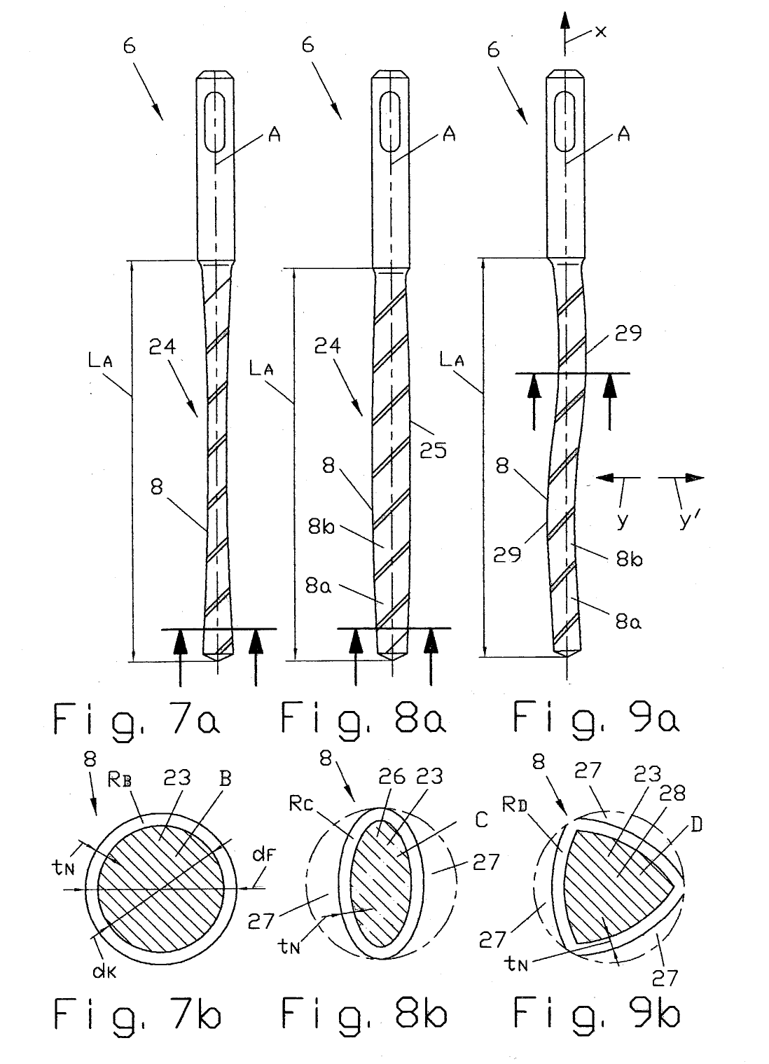

FIG. 7a shows a fifth design variant of a single-start drill,

FIG. 7b shows a cross section through the drill illustrated in FIG. 7a,

FIG. 8a shows a sixth design variant of a single-start drill,

FIG. 8b shows a cross section through the drill illustrated in FIG. 8a,

FIG. 9a shows a seventh design variant of a single-start drill,

FIG. 9b shows a cross section through the drill illustrated in FIG. 9a, and

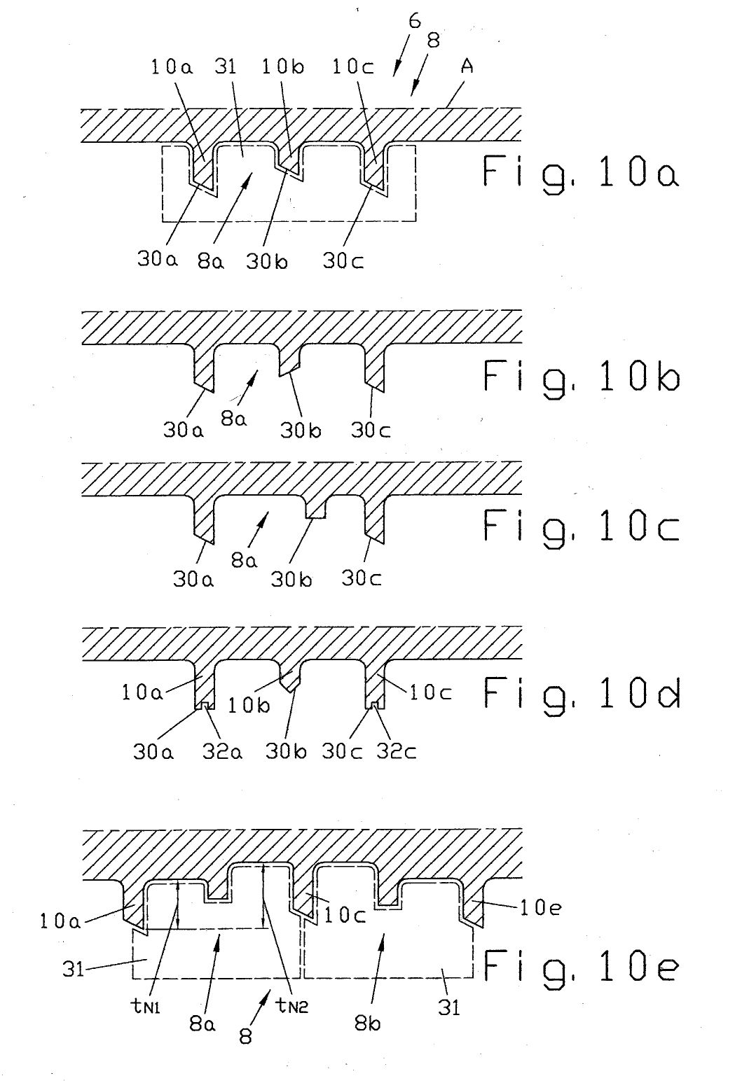

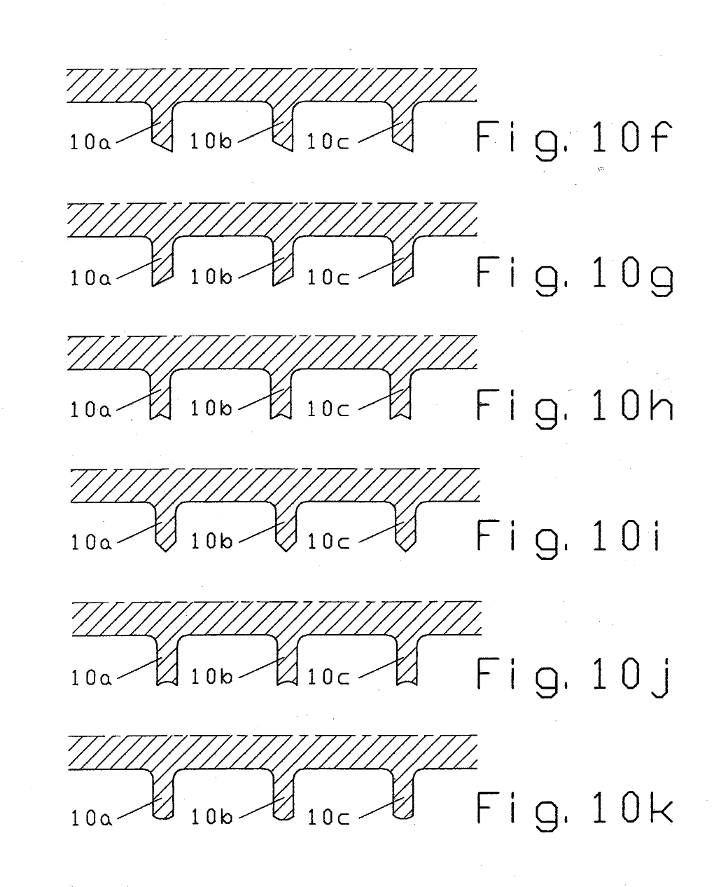

FIGS. 10a to 10k show details of cross sections of different drills in the region of the conveying helix.

FIG. 1 illustrates a side view of a sawn-off blank 1. The blank has a uniform diameter D_{R} over a length L_{R}.

FIG. 2 shows the blank illustrated in FIG. 1, machined at its ends, that is to say after a machining of a tip 2 and of an opposite end 3. The tip 2 is designed as a cone 4 and the end 3 is provided with a chamfer 5.

FIG. 3 shows a first variant of a drill 6 which is produced from the blank 1 by means of the method according to the invention. The drill 6 comprises a clamping shank 7 which is illustrated only partially by its region facing a helical region 8. The only partially illustrated clamping region located opposite the helical region 8 is designed as SDS-PLUS shank 33 (DE 37 16 915 A1). Alternatively, the design of other standard holders, for example of an SDS-MAX holder (DE 25 51 125 C2), may also be provided, or else the initial cross section may be left unchanged, for example cylindrical for holding in a clamping chuck.

The helical region 8 comprises a helix runout 9. The helical region 8 has conveying helices 8a, 8b with the what may be referred to as lands 10 and conveying flutes 11.

The clamping shank 7 has a corresponding diameter D_{E} or the associated shank radius (R_{E}) which is designed according to the desired standard holder and which corresponds to the diameter D_{R} of the blank shown in FIG. 1. Where what is known as an SDS-PLUS holder is concerned, the diameter D_{E} of the clamping shank 7 amounts to 10 mm. The helical region 8 or the conveying helices 8a, 8b have a conveying helix diameter d_{F} which is somewhat smaller than the nominal diameter d_{N} of the drill 6, since the nominal diameter d_{N} is defined by a cutting insert or cutting attachment 12. In drills without a cutting tip 12, the conveying helix diameter corresponds to the nominal diameter or is also called “nominal width”. The nominal diameter d_{N} or the diameter d_{F} of the conveying helix 8 of the drill 6 according to the invention is smaller than the diameter D_{E} of the clamping shank 7.

The land radius r_{F}, which gives the distance of the land 10 from the central longitudinal axis A of the drill 6, corresponds to half the conveying helix diameter d_{F} of the drill 6 which is somewhat smaller than the nominal diameter d_{N}.

The conveying helix flute 11 is worked in with a flute radius n into the drill 6. Said flute gives the distance between a flute bottom 13 and the longitudinal axis A of the drill 6. The difference between the shank radius R_{E} and the flute radius n results in the machining depth T which indicates the depth to which material is removed or displaced from a blank 1 (stripped contour illustrated by dashed lines 1′) during the production of one of the conveying helices 8a, 8b which takes place in one step. FIG. 3 shows clearly that, as compared with production methods customary at the present time by means of a diameter-adapted blank, an increased stripping of material or an increased displacement of material is necessary in order to produce the conveying helix.

As can be seen from FIG. 3, the land radius r_{F} is variable in the region of the helix runout 9. As seen in the direction from the drill tip 2 toward the clamping shank 7, the land radius r_{F} is enlarged continuously, until it reaches the shank radius (R_{E}) at the land end 14, the land 10 merging into the clamping shank 7.

Again, in the same way, as seen from the drill tip 2 toward the clamping shank 7, the flute radius n is enlarged until the flute radius n has reached the value R_{E} of the land radius of the flute end 15. The flute bottom 13 of the conveying flute 11 also merges correspondingly into the clamping shank 7 on the flute end 15. The flute end 15 is in this case offset axially to the land end 14.

In the embodiment illustrated, the conveying flute 11 is worked in, in particular milled, jointly with the land 10, into the bar-shaped blank 1 in a chip-removing manner. For this purpose, the blank 1 has, in the region of the conveying helix 8, a cylindrical initial form corresponding to the contour 1′ which is depicted by dashes and which corresponds to the illustrated region of the clamping shank 7. Machining can in this case take place basically from the tip 2 toward the clamping shank 7. However, a machining direction from the clamping shank 7 toward the tip 2 affords the advantage that machining can be commenced with a low cut-in depth.

In the present exemplary embodiment, the machining depth of the corresponding milling tool has been varied in such a way that the final dimension both of the land radius r_{F} and of the flute radius n has been reached even within one quarter revolution, that is to say during passage through an angle of 90°.

Such a rapid transition affords the advantage of as large a working length L_{A} of the helical region 8 as possible. The helical region 8 fits into the drillhole defined by the nominal diameter d_{N}, as long as the land radius r_{F} is smaller than or equal to half the nominal width d_{N}. With the enlargement of the land radius r_{F}, the drill 6, when introduced completely into the drillhole, comes into abutment. As can easily be seen, however, the flute 11 of the conveying helix 8 is continued toward the clamping shank 7, that is to say drill dust conveyance takes place beyond the region of enlargement of the land 10. Even when the drill 6 penetrates fully into the corresponding drillhole until it comes into abutment, the latter is not closed by the drill 6.

The flute end 15 and/or the land end 14, which constitute the cut-in or penetration points of the working tool into the blank 1, may be designed so as to be continuously curved or else with an edge, as can be seen by reference to the transition point 15.

The continuous transition of the land radius r_{F} and, in the present exemplary embodiment, also of the flute radius n give rise, over and above improved drill dust conveyance and favorable manufacture, to high rigidity of the drill 6 in the region of the helix runout 9 due to the avoidance of an adverse notch effect; this is beneficial to the useful life of the tool.

The hard-metal cutting tip 12 (illustrated by dashed lines) may be assigned to the drill 6 in the region of the tip 2 after the manufacture of the conveying helix 8. Said cutting tip is preferably held in a transverse slot arranged in the region of the tip 2. However, a solid hard-metal head may also be attached.

The double-start drill 6 illustrated in FIG. 3 has, with the exception of the conveying helix runout 9, two continuously uniform conveying helices 8a, 8b with a constant pitch angle P and also with a constant helix diameter d_{F} and land radius r_{F} and a constant bandwidth B_{R} or land width.

FIG. 4 shows a second design variant of a double-start drill 6. The drill 6 illustrated in FIG. 4 is manufactured in a similar way to the drill illustrated in FIG. 3. In a transitional region 16 in which a helical region 8 merges into a clamping shank 7, the drill 6 has a land 10 and a conveying flute 11 which run on cone envelopes 17, 18. The helical region 8 is formed by a multiplicity of small surfaces 19. These indicate what are known as facets which occur during the milling of conveying helices 8a, 8b forming the helical region 8. The edges of the surfaces 19 arise due to the fact that surfaces 19 lying next to one another meet at different angles. By virtue of the edges in the lateral region of the lands 10, the conveying helices 8a, 8b acquire good transport properties, since, during the rotation of the drill, the drill dust is pressed into the flute bottom 13 of the conveying flute 11 and therefore the friction of the drill dust on the drillhole wall is reduced.

FIG. 5 illustrates a further design variant of a double-start drill 6. As compared with the drills shown in FIGS. 3 and 4, the drill 6 shown in FIG. 5 possesses a differently configured helix runout 9. The helix runout 9 is designed here not as a continuous widening of a conveying helix 8a, 8b into a clamping shank 7, but as a contraction 20. The contraction 20 has a smallest diameter d corresponding approximately to double the front radius n. The contraction 20 is generated, in technical terms, by means of a brief standstill or slowing of the relative movement of the machine tool and the drill 6 in a longitudinal direction x. The transition to the clamping shank 7 takes place by means of a conical portion 21 which is an integral part of the helix runout 9. By the position of the machine tool in relation to the drill 6 being maintained briefly, a bead 22 can be formed in the helix runout 9, insofar as the tool is correspondingly profiled.

FIG. 6 illustrates a further design variant of a double-start drill 6. As compared with the drills shown in FIGS. 3 to 5, the drill 6 shown in FIG. 6 is not produced by chip-removing machining, but by means of a forming method, in particular by rolling. A transitional region 16 is designed as an abutment 34 toward a shank 7.

FIGS. 7a to 9b illustrate three further variants of single-start drills in a side view and in cross section. These drills have in common the fact that a core 23 of a conveying helix 8 has a circular, elliptic or curved-triangular cross section B, C, D. This cross section has, in its cross-sectional surface and/or in its orientation in relation to a longitudinal axis A of the drill, continuous variations, at least in regions, over a working length L_{A} of the conveying helix 8. A land 10 surrounding the core 23 describes correspondingly a circular, elliptic or curved-triangular ring R_{B}, R_{C}, R_{D} which surrounds the core 23.

As a result, according to the FIGS. 7a and 7b, a drill 6 which has a waisted helical region 8 is obtained. A drill 6 of this type, along with accurate guidance by the drilling machine, has low friction in the drillhole, since it does not rub against the drillhole wall in a middle narrowed region 24 of the helical region 8. A flute depth t_{N}, which may also be designated as the height of the land 10 or as the difference between the conveying helix diameter d_{F} and the core diameter d_{K}, is constant over the working length L_{A} of the helical region 8. This means that, over the working length L_{A}, with the difference remaining the same, the conveying helix diameter d_{F} and the core diameter d_{K} decrease continuously over approximately half the working length L_{A} and then increase continuously over the remaining working length L_{A}.

The drill 6 illustrated in FIGS. 8a and 8b possesses, in terms of the core 23, a constant elliptic cross-sectional surface C which is rotated continously through about 180° over a working length L_{A}. This results in the thickening 25, visible in the side view (FIG. 8a), in a middle region 24 of the helical region 8, since, here, the ellipse 26 shown in FIG. 8b is in a position rotated approximately through 90°. A drill 6 of this type makes it possible, in spite of a relatively large core diameter (long axis of the ellipse), to transport large quantities of drill dust, since the drill dust lying in free spaces 27 is also transported, in particular, owing to the screwlike twisting of the conveying helices 8a, 8b forming the helical region. The drill 6 has a constant flute depth t_{N}.

The drill 6 illustrated in FIGS. 9a and 9b possesses, in terms of a core 23, a constant cross-sectional surface D of a curved triangle 28, said cross-sectional surface being twisted continuously over a working length L_{A}. The twisting results in one-sided bulges 29. A drill 6 of this type, while having low friction on the drillhole wall, makes it possible to transport large quantities of drill dust in spite of a relatively large core diameter, the drill dust which lies in free spaces 27 (between the helical region of the drill and the drillhole wall) being conveyed out of the drillhole, in particular, owing to the screwlike twisting of the conveying helices 8a, 8b forming the helical region 8. The drill 6 has a constant flute depth t_{N}. During the manufacture of the drill 6, a milling cutter moves, for example in the x-direction, along the rotating drill 6 and at the same time, while maintaining the core cross-sectional surface D, travels alternately in opposite directions y, y′ transversely to the longitudinal direction x. As a result, the depth of penetration of the milling cutter into the blank is different, depending on the y-position. Such a manufacturing method is also suitable for producing the drill shown in FIGS. 8a and 8b.

FIGS. 10a to 10k illustrate, as a detail, diagrammatic cross sections through conveying helices.

FIG. 10a shows a helical region 8 of a drill 6 which is formed by a conveying helix 8a. The conveying helix 8a consists of two high lands 10a, 10c and of a small land 10b lying between these. All three lands 10a, 10b, 10c have land surfaces 30a, 30b, 30c which run at an inclination to a central longitudinal axis A of the drill 6. Dashed lines indicate diagrammatically in FIG. 10a a profiled machine tool 31 which forms the conveying helix 8a. Of course, in contrast to the illustration, during the actual milling operation the blank is machined only in the region in which the milling cutter 31 has already peeled off material.

FIGS. 10b and 10c show further variants of the design of helices 8a or land surfaces 30a, 30b, 30c.

FIG. 10d illustrates two lands 10a, 10c which have, toward a wall, not illustrated, of a drillhole, flutes 32a, 32c which run in land surfaces 30a, 30c. A land surface 30b of a land 10b has a gable-shaped design in cross section.

FIG. 10e shows a helical region 8 which is formed by two helices 8a, 8b. The two helices 8a, 8b are formed by machine tools 31 which are indicated diagrammatically by dashed lines. The machine tools 31 act on the blank in a time-staggered and/or spatially offset manner. Large lands 10a, 10c, 10e are formed completely only when both machine tools 31 have machined the blank, since one tool in each case forms about only half of these lands. The conveying flutes 11 belonging to the conveying helices 8a, 8b have different flute depths t_{N1} and t_{N2}. For forming a helix runout toward the drill shank, it is sufficient if one of the machine tools 31 machines the blank through 360° in the region of the helix runout.

FIGS. 10f to 10k illustrate further variants of the design of lands 10a, 10b, 10c. In this case, in particular, a different configuration of the land surfaces of the lands 10a, 10b, 10c is provided. The land surfaces are designed, in cross section, as V-shaped or U-shaped projections or setbacks or slopes.

The invention is not restricted to exemplary embodiments illustrated or described. On the contrary, it embraces developments of the invention within the scope of the patent claims. In particular, as already mentioned, the method according to the invention may also be used for varying the pitch of the conveying helix over at least one portion of the conveying helix by a change in the advancing speed. In this case, the variation in the advancing speed, along with the same machining depth and with a corresponding tool selection, gives rise at the same time to a variation in the land width which is often also called the bandwidth and is not to be confused with the land radius.

Both the core diameter and the profile of the conveying flute may likewise be varied by a variation in the machining depth. This profile of the conveying flute depends correspondingly on the selection of the machine tool used. Depending on the form of the corresponding machine tool, a variation in the machining depth of the machine tool may also influence the geometry of the conveying flute or of the land in addition to the core diameter.

By virtue of the variations described, for example, drills or milling cutters can be produced which have only a helix diameter or land radius with a constant pitch and bandwidth (land width). Such drills cause, for example, a lower friction in the drillhole.

Tools with variations in the pitch and bandwidth may also be envisaged, in which case the helix diameter may be constant or likewise be varied.

What is essential to the method according to the invention, at all events, is the manufacture of the conveying helix in one operation from a bar-shaped blank.

### List of Reference Symbols

1 blank

1′ initial contour of the blank

2 tip of 1 or 6

3 end of 1 or 6

4 cone

5 chamfer

6 drill

7 clamping shank

8 helical region

8a, 8b conveying helix

9 conveying helix runout

10 land

10a, 10b, 10c land

11 conveying flute

12 hard-metal tip

13 flute bottom

14 land end

15 flute end

16 transitional region (8 into 7)

17 cone envelope

18 cone envelope

19 small surface

20 contraction

21 conical portion of 9

22 bead

23 core

24 middle region of 8

25 thickening

26 ellipse

27 free space

28 triangle

29 bulge

30a, 30b, 30c land surface of 10

31 machine tool

32a, 32c flute in 10a and 10c

33 SDS-plus shank

34 abutment

A central longitudinal axis of 6

B cross-sectional area circle

B_{R} land width

C cross-sectional surface of 26

D cross-sectional surface of 28

D_{E} shank diameter

D_{R} diameter of 1

d diameter of contraction 20

d_{F} diameter of 8 (conveying helix diameter)

d_{K} core diameter

d_{N} nominal width

L_{A} working length of 8

L_{R} length of 1

n flute radius

p pitch angle

R_{E} shank radius

r_{F} land radius

T machining depth=R_{E}−n

t_{N}, t_{N1}, t_{N2} flute depth

1. A method for the production of a tool, in particular a drill (6) or milling cutter, having at least one conveying helix (8a, 8b), proceeding from a bar-shaped blank (1), wherein the conveying helix (8a, 8b) is introduced in a single operation, the blank (1) having a diameter (D_{R}) which is larger than a diameter (d_{F}) of the conveying helix (8a, 8b).

2. The method as claimed in claim 1, wherein the blank (1) is set in rotation in relation to the machine tool (31) and an advance of the machine tool (31) and/or of the blank (1) in a longitudinal direction (x) and/or transverse direction (y) of the blank (1) takes place.

3. The method as claimed in claim 1, wherein the machine tool (31) rotates about the stationary or rotating blank (1), an advance of the machine tool (31) and/or of the blank (1) in a longitudinal direction x and/or transverse direction y of a blank (1) taking place.

4. The method as claimed in one of the abovementioned claims, wherein the advancing speed or the relative speed of the blank and of the machine tool in relation to one another is varied during the advance.

5. The method as claimed in one of the abovementioned claims, wherein the variation in the machining depth (T) and/or in the advancing speed is carried out continuously.

6. The method as claimed in one of the preceding claims, wherein the bar-shaped blank (1) has a diameter (D_{R}) which is constant over its entire length (L_{R}).

7. The method as claimed in one of the abovementioned claims, wherein a blank (1) with a standardized holder (for example, SDS-Plus or SDS-Max) for standardized hammer-drilling machines is used.

8. The method as claimed in one of the preceding claims, wherein the tool (6) has generated on it, between the helix (8) and the clamping shank (7), a helix runout (9) which is obtained as a result of a slowed relative movement of the tools (6, 31) in the x-direction or of an accelerated rotation of the tool (6) about its longitudinal axis (A) or of an accelerated rotation of the machine tool (31) about the tool (6).

9. The method as claimed in one of the abovementioned claims, wherein the helix runout (9) is worked, in the same operation as the conveying helix (8), into a bar-shaped blank (1), in which, proceeding from the shank radius (R_{E}) or leading toward the latter, the machining depth (T) is varied as a function of the advance.

10. The method as claimed in one of the abovementioned claims, wherein the helix runout (9) is applied over an angular range of 10° to 180° and preferably 90°.

11. The method as claimed in one of the abovementioned claims, wherein the transition of the helix (8a, 8b) into the shank region (7) is introduced by means of a 360°-rotation.

12. The method as claimed in one of the abovementioned claims, wherein the conveying helix (8) is worked in by chip removal or by forming.

13. The method as claimed in one of the preceding claims, wherein the conveying helix (8) is produced by means of a chip-removing method, such as, for example, milling, which is followed, in particular, by a re-machining of the conveying helix by rolling for surface compaction.

14. The method as claimed in one of the preceding claims, wherein the conveying helix (8) is produced by means of a forming method, such as, for example, extrusion, the bar-shaped blank (1) preferably being pressed by means of a die.

15. The method as claimed in one of the preceding claims, wherein, depending on the machine tool, the flute depth (t_{N}) obtained is always constant.

16. A tool, in particular drill or milling cutter, with a clamping shank (7), with a shank radius (R_{E}) and with at least one conveying helix (8a, 8b), wherein the conveying helix (8a, 8b) is produced according to one of the abovementioned claims.

17. The tool as claimed in claim 16, wherein the pitch (P), the land width (B_{R}) and the helix diameter (d_{F}) or land radius are constant outside the region of the helix runout.

18. The tool as claimed in claim 16, wherein the helix diameter (d_{F}) or land radius of the conveying helix (8) is varied.

19. The tool as claimed in claim 16, wherein the pitch (P) and the bandwidth (B_{R}) or land width of the conveying helix (8a, 8b) are varied, with the helix diameter (d_{F}) or land radius being constant.

20. The tool as claimed in claim 16, wherein both the pitch (P), the bandwidth (B_{R}) or land width and the helix diameter (d_{F}) or land radius are varied.

21. The tool as claimed in claim 16, wherein the conveying helix (8) has a helix runout (9) which is designed with an enlargement of the land radius (r_{F}) toward the clamping shank (7).

22. The tool as claimed in one of claims 16 to 21, wherein the helix runout (9) merges into the clamping shank (7) via a continuous symmetric transition and/or via an abutment (34).

23. The tool as claimed in one of claims 16 to 22, wherein the land (10) of at least one conveying helix (8a, 8b) is inclined with respect to the drill longitudinal axis (A).

24. The tool as claimed in one of claims 16 to 23, wherein the helix diameter (d_{F}) is varied.

25. The tool as claimed in one of claims 16 to 24, wherein the helix diameter (d_{F}) is varied, with the cross-sectional form being the same.

26. The tool as claimed in one of claims 16 to 25, wherein the helix diameter (d_{F}) is varied, with a varying cross-sectional form.

27. The tool as claimed in one of claims 16 to 26, wherein the flute depth (t_{N}) is always constant, irrespective of the profile form.
